(19) United States
(12) Patent Application Publication
(10) Pub. No.: US 2016/0325466 A1
(43) Pub. Date: Nov. 10, 2016

(54) METHOD FOR CUTTING WORKPIECE

(71) Applicant: KOBELCO RESEARCH INSTITUTE, INC., Kobe-shi (JP)

(72) Inventors: Kazuo YOSHIKAWA, Hyogo (JP); Masanori ANAN, Hyogo (JP); Akinori URATSUKA, Hyogo (JP); Yoshitake MATSUSHIMA, Hyogo (JP)

(73) Assignee: KOBELCO RESEARCH INSTITUTE, INC., Kobe-shi (JP)

(21) Appl. No.: 15/109,907

(22) PCT Filed: Jan. 9, 2015
(86) PCT No.: PCT/JP2015/050486

§ 371 Date: Jul. 6, 2016

(30) Foreign Application Priority Data
Jan. 9, 2014 (JP) 2014-002740

(51) Int. Cl. B28D 1/08

(52) U.S. Cl. CPC B28D 1/088

(57) ABSTRACT

A method for cutting a workpiece except silicon includes moving a resin-coated saw wire having a resin coating that covers the surface of a steel wire. In the method, at least one of the resin-coated saw wire or the workpiece is swung, a diamond abrasive grain having an average grain size of more than 0 μm and 8 μm or less is sprayed onto the resin-coated saw wire, and a wire running speed of the resin-coated saw wire is 800 m/min or higher.

### TECHNICAL FIELD

The present invention relates to a method for cutting a workpiece except silicon by moving a resin-coated saw wire that has a resin coating on the surface of a steel wire.

### BACKGROUND ART

A workpiece such as silicon carbide or silicon is cut using a wire-saw machine assembled with a saw wire. The saw wire moves in one direction or in two directions (in a reciprocating direction) and, when the saw wire is brought into contact with a workpiece, the saw wire can slice the workpiece in an arbitrary thickness.

The technique for cutting the workpiece could be, depending on the kind of the abrasive grains to be used therein, broadly classified into a loose abrasive technique where a workpiece is cut while spraying a slurry that contains abrasive grains onto a saw wire formed of a steel wire, and a fixed abrasive technique where a workpiece is cut using a fixed abrasive-bearing saw wire that has a plating layer formed by adhering and fixing abrasive grains onto the surface of a base wire formed of a steel wire. A process of cutting a workpiece according to the loose abrasive technique and the fixed abrasive technique mentioned above is described with reference to schematic views of FIG. 1 (a) and FIG. 1(b). In FIG. 1 (a) and FIG. 1(b), 11 indicates a steel wire, 12 indicates a saw wire formed of a steel wire, 13 indicates an arrow showing the moving direction of the saw wire, 14 indicates a workpiece, 15 indicates a loose abrasive, 16 indicates a plating layer, 17 indicates a fixed abrasive, and 18 indicates a fixed abrasive-bearing saw wire.

According to the loose abrasive technique, as shown in FIG. 1 (a), the abrasive grains contained in a sprayed slurry are introduced into the space between the workpiece 14 and the saw wire 12 as loose abrasives 15, thereby accelerating the abrasion of the workpiece 14 and accelerating grinding of the workpiece 14 to cut it. In turn, according to the fixed abrasive technique, as shown in FIG. 1 (b), the fixed abrasives 17 fixed to the surface of the steel wire 11 via the plating layer 16 accelerates the abrasion of the workpiece 14, thereby accelerating the grinding of the workpiece 14 to cut it.

According to the loose abrasive technique, the roughness of the surface of the cut article may be small as compared with that in the fixed abrasive technique, and the quality of the cut article may tend to be better. In turn, according to the fixed abrasive technique, the slicing speed for workpieces may be increased as compared with that in the loose abrasive technique, and the productivity of cut articles may tend to increase. The slicing speed may differ depending on the kind of workpieces or the like; however, for example, in the case where a silicon carbide ingot having a diameter of 2 inches is cut, it is known that the slicing speed is about 0.05 mm/min and the waviness of the surface of the cut article is about 20 to 40 μm in the loose abrasive technique, while in the fixed abrasive technique, the slicing speed could be increased to about 0.1 mm/min but, on the other hand, the waviness of the surface of the cut article increases to about 30 to 50 μm. In the case where a silicon ingot having a lower hardness than silicon carbide is cut, it is said that the slicing speed is about 0.3 mm/min in the loose abrasive technique while in the fixed abrasive technique, the slicing speed could be increased to about 0.7 mm/min.

As techniques corresponding to the loose abrasive technique and the fixed abrasive technique mentioned above, for example, Patent Documents 1 to 3 may be referred to. Specifically, a technique of preventing a saw wire from being broken by reducing the load to be given to the saw wire in cutting a workpiece is proposed, for example, in Patent Document 1. A technique of suppressing variation in the thickness of the workpiece cut with a saw wire is proposed, for example, in Patent Documents 2 and 3.

Patent Documents 1 to 3 disclose a technique of cutting a workpiece while spraying a slurry that contains abrasive grains onto a saw wire formed of a steel wire, and the technique corresponds to the above-mentioned loose abrasive technique. In turn, Patent Document 2 discloses a technique of cutting a workpiece using a saw wire that has a plating layer formed on the surface of a steel wire where abrasive grains are fixed to the plating layer, and this technique corresponds to the above-mentioned fixed abrasive technique.

On the other hand, in Patent Document 4, the present applicant has proposed, as a technique corresponding to the above-mentioned loose abrasive technique, a saw wire having, as formed on the surface of a steel wire, a resin coating without containing abrasive grains, the resin coating having a hardness of 0.07 GPa or more at 120° C., in which the hardness of the resin coating is so controlled that the abrasive grains to be sprayed thereonto in cutting a workpiece may be prevented from introducing into the resin coating. In Examples of Patent Document 4, a case of cutting single-crystal silicon softer than silicon carbide, as a workpiece, is disclosed, and the slicing speed of the single-crystal silicon is varied within a range of 0.1 to 0.3 mm/min while spraying a slurry that contains diamond abrasive grains having an average grain size of 5.6 μm and the wire running speed of the saw wire is 500 m/min. In the case of using the resin-coated saw wire described in Patent Document 4, the surface of the cut workpiece is smooth and the surface roughness thereof is small, as compared with those in the case of using a saw wire formed of a steel wire. Specifically, Patent Document 4 describes that the arithmetic mean roughness Ra at the cut surface of single-crystal silicon can be suppressed to 0.5 μm or less.

### CITATION LIST

### Patent Literature

Patent Document 1: JP-A-H10-249699
Patent Document 2: JP-A-2008-229752
Patent Document 3: Japanese Patent 3692703
Patent Document 4: JP-A-2013-56411

### SUMMARY OF INVENTION

### Technical Problem

As described above, in Examples of Patent Document 4, silicon is used as a workpiece and the effect has been confirmed.

Recently, a technique of cutting, by using the saw wire, a high-hardness material such as silicon carbide, sapphire and gallium nitride that has a higher hardness and is therefore more poorly workable than silicon has been investigated, and mainly a fixed abrasive technique capable of realizing a high slicing speed is employed. However, there is a worrisome issue of quality degradation such as the increase in the waviness of cut articles. Given the situation, the present applicant tried cutting the above-mentioned high-hardness material using the above-mentioned resin-coated saw wire of Patent Document 4 that employs a loose abrasive technique, with increasing the wire running speed of the resin-coated saw wire for improving productivity. As a result, it has been found that the arithmetic mean roughness Ra of the cut articles could be reduced to 0.5 μm or less but there occurs waviness in the surface of the cut articles. The resultant cut articles may be polished in a later step to give wafers. When the waviness of the surface of the cut articles is large, the polishing loss in a polishing step is large, and therefore in such a case, the cut articles must be thick in order that wafers having a predetermined thickness are produced, resulting in material yield reduction, cost increase and productivity reduction.

In Patent Document 4, a resin-coated saw wire having a resin coating whose hardness at 120° C. is high is used, but it is considered that the above-mentioned problems would similarly occur also in a case of using a saw wire having a resin coating, irrespective of the hardness of the resin coating.

The present invention has been made in consideration of the above-mentioned circumstances, and an object thereof is to provide a method for cutting a workpiece except silicon (preferably a high-hardness material such as silicon carbide, sapphire and gallium nitride), by using a resin-coated saw wire that has a resin coating that covers the surface of a steel wire, which causes neither abrasion of the resin coating nor breaking of the resin-coated saw wire in the course of cutting even when the wire running speed of the resin-coated saw wire is increased to 800 m/min or higher in order to improve the productivity, and which can reduce the arithmetic mean roughness (Ra) of the cut articles and the waviness thereof. Specifically, in the present invention, a technique capable of improving the quality of cut articles without sacrificing the productivity in producing the cut articles by cutting workpieces is produced.

### Technical Solution

The present invention which could solve the above problems provides a method for cutting a workpiece except silicon, the method including moving a resin-coated saw wire having a resin coating that covers the surface of a steel wire, and the main point thereof is that at least one of the resin-coated saw wire or the workpiece is swung, a diamond abrasive grain having an average grain size of more than 0 μm and 8 μm or less is sprayed onto the resin-coated saw wire, and a wire running speed of the resin-coated saw wire is 800 m/min or higher.

The average grain size of the diamond abrasive grain is preferably more than 0 μm and 5 μm or less. The wire running speed of the resin-coated saw wire is preferably 1000 m/min or higher. The feature that at least one of the resin-coated saw wire or the workpiece is swung means that a degree of swing in a direction of a normal line that passes through the central axis of the workpiece, among normal lines of the resin-coated saw wire, is more than 0 degree. The degree of swing is preferably more than 0 degree and 7 degrees or less. A hardness of the resin coating at 120° C. is preferably 0.07 GPa or more. The resin is preferably polyurethane, polyimide or polyamide-imide.

### Advantageous Effects of Invention

In the present invention, in cutting a workpiece except silicon by moving a resin-coated saw wire that has a resin coating that covers the surface of a steel wire, at least one of the resin-coated saw wire or the workpiece is swung, a diamond abrasive grain having an average grain size of more than 0 μm and 8 μm or less is sprayed onto the resin-coated saw wire, and the wire running speed of the resin-coated saw wire is controlled to 800 m/min or higher. As a result, without specifically controlling the hardness of the resin coating that covers the surface of the steel wire, and with the slicing speed for the workpiece increased to about 0.1 mm/min, for example, in the case of a silicon carbide ingot, for enhancing the productivity, not only the resin coating can be prevented from being worn away in cutting but also the resin-coated saw wire can be prevented from being broken and, in addition, the arithmetic mean roughness Ra of the surface of the cut workpiece can be reduced and the waviness thereof can also be reduced.

### BRIEF DESCRIPTION OF DRAWINGS

FIG. 1 includes schematic views each illustrating how to cut a workpiece with a different kind of saw wire.

FIG. 2 is a schematic view illustrating how to cut a workpiece through contact of a resin-coated saw wire with the workpiece while the workpiece is fixed to the seat mounted on a wire-saw machine and while the moving resin-coated saw wire is swung.

FIG. 3 is a schematic view illustrating how to cut a workpiece through contact of a resin-coated saw wire with the workpiece while the workpiece fitted to the seat mounted on a wire-saw machine is swung along with the seat relative to the moving resin-coated saw wire.

FIG. 4 (a) and FIG. 4(b) each are a photograph substituted for drawing of a section of a cut article.

FIG. 5 is a photograph substituted for drawing of cutting chips taken with a scanning electron microscope.

FIG. 6 is a photograph substituted for drawing of cutting chips taken with a scanning electron microscope.

FIG. 7 is a graph showing a result of analysis of cutting chips with a laser Raman microspectrophotometer.

### DESCRIPTION OF EMBODIMENTS

In the present invention, the technique of the above-mentioned Patent Document 4 has been improved, and the present invention relates to a technique of cutting a workpiece except silicon (preferably a high-hardness material such as silicon carbide, sapphire and gallium nitride) with a loose abrasive technique using a resin-coated saw wire that has a resin coating that covers the surface of a steel wire (here, the hardness thereof at 120° C. is not specifically limited), thereby giving a cut article having excellent surface quality with good productivity.

In cutting a workpiece except silicon by moving a resin-coated saw wire having a resin coating that covers the surface of a steel wire, the present inventors have assiduously studied for the purpose of preventing the resin coating from being worn away and for the purpose of reducing the arithmetic mean roughness Ra of the surface of the cut article obtained by cutting the workpiece and of reducing the waviness thereof even when the wire running speed of the resin-coated saw wire is adjusted to be 800 m/min or more and the productivity is enhanced. As a result, the inventors have found that, in cutting a workpiece, when at least one of the resin-coated saw wire or the workpiece is swung in such a manner that the direction of the normal line passing through the central axis of the workpiece among normal lines of the resin-coated saw wire could be swung while diamond abrasive grains having an average grain size of more than 0 μm and 8 μm or less are sprayed onto the resin-coated saw wire and the wire running speed of the resin-coated saw wire is 800 m/min or higher, then the arithmetic mean roughness Ra and the waviness of the cut article could be reduced, and then, the present invention has been completed.

Specifically, irrespective of the loose abrasive technique or the fixed abrasive technique mentioned above, in general, when the average grain size of the abrasive grains is made smaller, the arithmetic mean roughness Ra and waviness of the surface of the cut article are reduced and the quality of the cut article improves. However, it is known that, with the reduction in the average grain size of the abrasive grains, the grindability worsens and consequently the slicing speed of the workpiece lowers. Heretofore, for increasing the slicing speed of workpieces, relatively large-size abrasive grains must be used. On the other hand, it is known that, when large-size abrasive grains are used, the arithmetic mean roughness Ra and waviness of the surface of the cut articles increase. Specifically, the productivity typically expressed by a slicing speed or the wire running speed of a saw wire and the quality of the surface of the cut article typically expressed by Ra and waviness are in a trade-off relationship, and it has been considered that it is difficult to satisfy both of them at the same time. Heretofore, for improving the productivity by increasing the slicing speed of workpieces, the quality of the cut articles has been sacrificed within an acceptable range.

As opposed to this, in the present invention, in cutting a workpiece except silicon by using a resin-coated saw wire having a resin coating that covers the surface of a steel wire, at least one of the resin-coated saw wire or the workpiece is swung and, in addition, relatively small-size diamond abrasive grains having an average grain size of more than 0 μm and 8 μm or less are used, and accordingly, it has been verified that the workpiece is cut in a mechanism different from that for cutting the workpiece without swinging the resin-coated saw wire and the workpiece. As a result, a high slicing speed can be secured like in the case where a fixed abrasive technique is employed, and without sacrificing the slicing speed, that is, without sacrificing the productivity, the quality of wafers, that is, the arithmetic mean roughness Ra and the waviness thereof can be reduced. These effects can be attained more noticeably by increasing the wire running speed of the saw wire. The process in completing the present invention is described below.

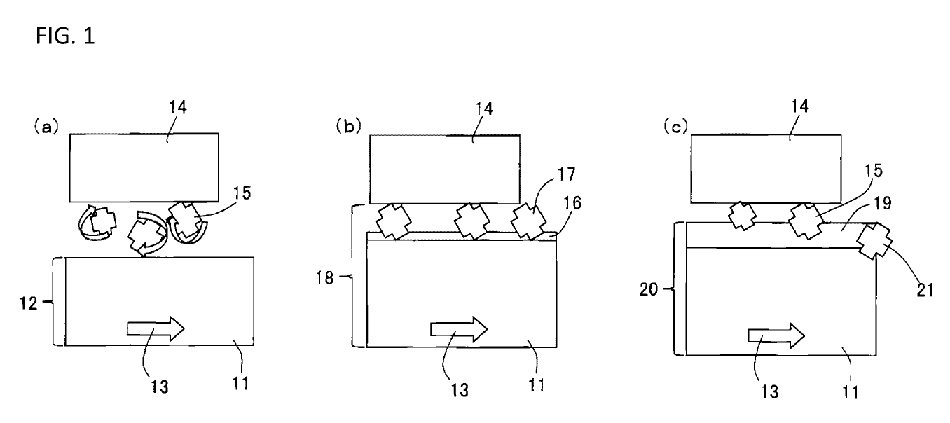

In cutting a workpiece by using a resin-coated saw wire, a slurry that contains abrasive grains are sprayed onto the resin-coated saw wire in order that loose abrasives could exist in the space between the resin-coated saw wire and the workpiece. As shown in FIG. 1 (c), the abrasive grains contained in the sprayed slurry are supplied to the space between the resin-coated saw wire 20 and the workpiece 14, as loose abrasives 15. The loose abrasives 15 introduced into the space are continuously held by the resin coating 19 and grind the workpiece 14, seemingly clawing it. When the loose abrasives 15 held by the resin coating 19 reach the end of the workpiece, the loose abrasives 15 held by the resin coating 19 are readily released from the resin coating, as shown by 21. Consequently, few loose abrasives 15 adhere to the surface of the resin-coated saw wire that has cut the workpiece 14.

In that manner, in cutting a workpiece, loose abrasives must exist in the space between the workpiece and the resin-coated saw wire, and it is considered that when more loose abrasives exist therebetween, the workpiece could be cut more. In a loose abrasive technique, the abrasive grains concentration in the case of using diamond abrasive grains is generally about 30 to 50% by mass. However, as a result of repetition of various experiments made by the present inventors, it has been found that, in the present invention, since a resin-coated saw wire having a resin coating that covers the surface of a steel wire is used, the abrasive grains concentration must be lowered greatly for preventing the resin coating from being worn away. The amount of the loose abrasives capable of being introduced into the resin coating is limited, and it has been found that, when the amount of the loose abrasives that exist in the above-mentioned space but do not contribute to grinding of workpieces increases, the resin coating may be ground by the excessive loose abrasives and may be thereby worn away. It is considered that only a slight part of all the loose abrasives could contribute to grinding, and the present inventors have reached the thought that a cutting technique of introducing only the effective abrasive grains into the space between the workpiece and the resin-coated saw wire while the other excessive abrasive grains to cause resin abrasion are not introduced thereinto is effective.

Given the situation, the present inventors have considered that, in cutting a workpiece with the above-mentioned resin-coated saw wire, when at least one of the resin-coated saw wire or the workpiece is swung, then excessive abrasive grains to cause resin abrasion could be prevented from being introduced thereinto without detracting from the introduction of the abrasive grains that contribute to grinding. In addition, the inventors have further considered that, by reducing the number of the excessive abrasive grains, the arithmetic mean roughness Ra of the surface of the cut article could be reduced after cutting and the waviness thereof could also be reduced, without sacrificing the slicing speed. By reducing the waviness, the polishing loss in the later step could be reduced and therefore, the material yield could be improved and the productivity could also be improved to thereby reduce the material cost.

As a result of various investigations, it has been found that the abrasive grains to be used in this case should be diamond abrasive grains having an average grain size of more than 0 μm and 8 μm or less and that the wire running speed of the resin-coated saw wire must be 800 m/min or higher.

In addition, in the present invention, it is enough to use a saw wire having a resin coating that covers the surface of a steel wire, and preferably the hardness of the resin coating that covers the surface of the steel wire is controlled like in the case of Patent Document 4. In the present invention, in cutting a workpiece, at least one of the resin-coated saw wire or the workpiece is swung, and therefore, even when the resin coating that covers the surface of the steel wire is soft, for example, even when the hardness thereof at 120° C. is lower than 0.07 GPa, the resin coating is worn little in cutting.

Regarding the abrasion of the resin coating, the difference between the present invention and the related art is described in more detail. In the saw wire formed of a steel wire used in the above-mentioned loose abrasive technique, the surface of the steel wire is not covered with a resin coating, and therefore in such a case, even when a large amount of loose abrasives are supplied to the space between the saw wire and a workpiece, the problem of resin coating abrasion does not occur. In addition, also in the saw wire with the fixed abrasives used in the fixed abrasive technique, a resin coating does not cover the surface of the steel wire, and naturally in cutting a workpiece, a slurry that contains abrasive grains is not sprayed, and therefore, there should not occur any problem of resin coating abrasion.

In the present invention, it is enough to swing at least one of the resin-coated saw wire or the workpiece and, for example, it is unnecessary to change the swing angle in the course of cutting the workpiece, unlike the case disclosed in the above-mentioned Patent Document 3. Specifically, in the part at which cutting of an ingot is started and in the part at which cutting thereof is ended, abrasive grains may readily enter the cut grooves and the width of the cut grooves of the ingot tends to increase. Therefore, in the above-mentioned Patent Document 3, the swing angle of the wire line is controlled in accordance with contact length between the wire line and the ingot in order that the width of the cut grooves in the part at which cutting of the ingot is started and in the part at which cutting thereof is ended could not increase, thereby controlling the amount of the abrasive grains to be introduced into the grooves. As opposed to this, in the present invention, since a saw wire having a resin coating that covers the surface of a steel wire is used as the saw wire, not only in the part at which cutting of a workpiece is started and in the part at which cutting thereof is ended but also even in the course of cutting, loose abrasives are introduced into the resin coating to be supplied to the space between the resin-coated saw wire and the workpiece. As a result, cutting unevenness of workpieces could be prevented, and therefore, in the course of cutting workpieces, it is unnecessary to change the swing angle of the resin-coated saw wire or the workpiece. Consequently, in the present invention, the wire-saw machine structure may be simplified.

The method for cutting a workpiece in the present invention is described in detail hereinunder.

The cutting method for a workpiece in the present invention includes a step of cutting a workpiece except silicon by moving a saw wire having a resin coating that covers the surface of a steel wire, and at least one of the resin-coated saw wire or the workpiece is swung, a diamond abrasive grains having an average grain size of more than 0 μm and 8 μm or less is sprayed onto the resin-coated saw wire, and the wire running speed of the resin-coated saw wire is 800 m/min or higher.

First, swinging of the resin-coated saw wire or the workpiece that is a feature of the present invention is described.

In the present invention, it is important that at least one of the resin-coated saw wire or the workpiece is swung. By swinging at least one of the resin-coated saw wire or the workpiece, it is possible to prevent abrasive grains not contributing to grinding of the workpiece from being introduced into the space between the resin-coated saw wire and the workpiece in cutting the workpiece. As a result, cutting of the workpiece can be accelerated, the arithmetic mean roughness Ra of the surface of the cut article produced by cutting the workpiece can be reduced and the surface can be prevented from having waviness.

Swinging the resin-coated saw wire or the workpiece means that, among normal lines of the resin-coated saw wire, the degree of swing in the direction of the normal line passing through the central axis of the workpiece is controlled to be more than 0 degree. Specifically, in cutting a workpiece by moving a resin-coated saw wire, when neither the resin-coated saw wire nor the workpiece is swung, the direction of the normal line passing through the central axis of the workpiece among normal lines of the resin-coated saw wire is always constant, and the degree of swing in this case is 0 degree. As opposed to this, when at least one of the resin-coated saw wire or the workpiece is swung, the contact point between the resin-coated saw wire and the workpiece varies, and therefore, among the normal lines of the resin-coated saw wire, the direction of the normal line passing through the central axis of the workpiece also changes. As a result, the degree of swing is more than 0 degree.

As the lower limit of the degree of swing, it is preferably 0.2 degrees or more, more preferably 0.3 degrees or more, even more preferably 0.4 degrees or more.

As the maximum value of the degree of swing, it is preferably 7 degrees or less. As a result of various experiments and investigation thereon made by the present inventors, it has been found that, when the maximum value of the degree of swing is more than 7 degrees, the loose abrasives excessively exist in the space between the resin-coated saw wire and the workpiece so that the resin coating is excessively worn away in the course of cutting workpieces, the base wire is thereby exposed, worn away and damaged, and the resin-coated saw wire is often broken. As the maximum value of the degree of swing, it is preferably 3 degrees or less, more preferably 2 degrees or less.

From the viewpoint of preventing vibration of wire-saw machines, the degree of swing is preferably 0.2 to 2 degrees.

As the method for controlling the degree of swing to be more than 0 degree by swinging at least one of the resin-coated saw wire or the workpiece, examples thereof include the following methods.

(1) A method in which a workpiece is fixed to the seat mounted on a wire-saw machine and a resin-coated saw wire is brought into contact with the workpiece while swinging the resin-coated saw wire, and the degree of swing is controlled.

(2) A method in which the resin-coated saw wire is not swung but is moved, for example, in a horizontal direction and a workpiece fixed to a seat is brought into contact with the resin-coated saw wire while swinging the workpiece fixed to the seat along with the seat, and the degree of swing is controlled.

The above (1) and (2) are described concretely with reference to the drawings.

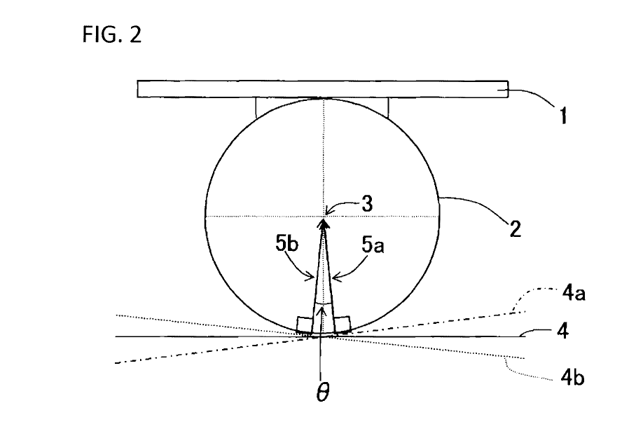

FIG. 2 is a schematic view for explaining the above-mentioned method (1). 1 is a seat, 2 is a workpiece, 3 is a central axis of the workpiece, 4 is a resin-coated saw wire, 5a and 5b each indicates the direction of the normal line passing through the central axis 3 among normal lines of the resin-coated saw wire, and θ indicates a degree of swing.

In FIG. 2, the workpiece 2 is fixed to the seat 1, and the resin-coated saw wire 4 is swung in the vertical direction by the degree of swing θ while moving the resin-coated saw wire. Specifically in FIG. 2, the resin-coated saw wire 4 moving in the horizontal direction is swung in the vertical direction so as to reciprocate between the position 4a shown by the dot-and-dash line and the position 4b shown by the dot-line.

When the resin-coated saw wire is at the position 4a shown by the dot-and-dash line, the direction of the normal line passing through the central axis 3 among the normal lines of the resin-coated saw wire 4a, is 5a. In turn, when the resin-coated saw wire is at the position 4b shown by the dot-line, the direction of the normal line passing through the central axis 3 among the normal lines of the resin-coated saw wire 4b is 5b. In FIG. 2, the angle between the direction of the normal line 5a and the direction of the normal line 5b is referred to as a degree of swing θ, and in the present invention, the resin-coated saw wire 4 may be swung in such a manner that the degree of swing θ could be more than 0 degree and preferably 7 degrees or less. The degree of swing θ corresponds to the angle between the resin-coated saw wire at the position 4a and the resin-coated saw wire at the position 4b.

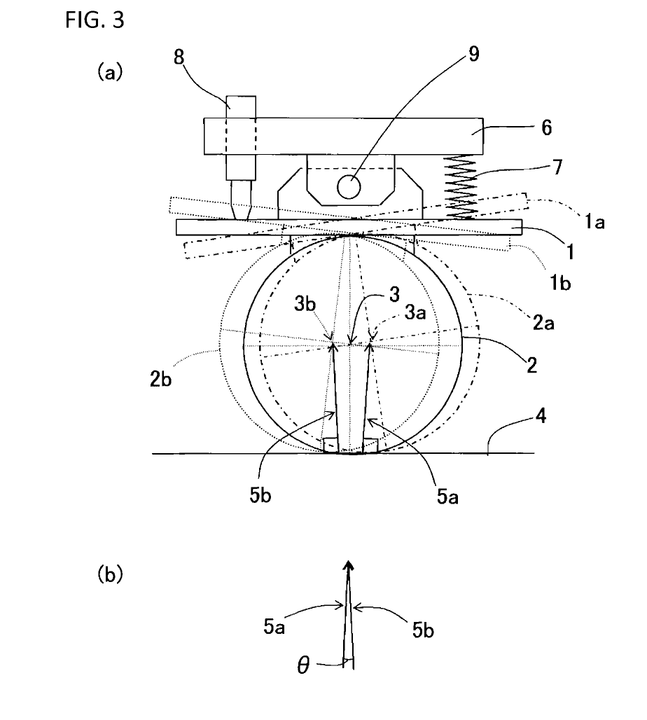

FIG. 3 is a schematic view for explaining the above-mentioned method (2). The parts overwrapping those in the above-mentioned FIG. 2 each are given the same reference sign. In FIG. 3 (a), 6 is a seat, 7 is a spring, 8 is an air cylinder, and 9 is a rotational axis. FIG. 3 (b) is a view for explaining the angle between the direction of the normal line 5a and the direction of the normal line 5b shown in FIG. 3 (a).

In FIG. 3 (a), the spring 7 and the air cylinder 8 are fixed to the seat 6 via the rotational axis 9 arranged therebetween for swinging the seat 1, and by operating the air cylinder 8, the workpiece 2 fixed to the seat 1 is swung in the horizontal direction around the rotational axis 9 as the center. Specifically, in FIG. 3 (a), the resin-coated saw wire 4 moves in the horizontal direction, and the workpiece 2 is swung in the horizontal direction so as to reciprocate in the moving direction of the resin-coated saw wire 4 between the position 2a shown by the dot-and-dash line and the position 2b shown by the dot-line.

When the workpiece 2 is at the position 2a shown by the dot-and-dash line, the direction of the normal line passing through the central axis 3a of the workpiece 2a, among the normal lines of the resin-coated saw wire 4, is 5a. In turn, when the workpiece 2 is at the position 2b shown by the dot-line, the direction of the normal line passing through the central axis 3b of the workpiece 2b, among the normal lines of the resin-coated saw wire 4, is 5b.

In FIG. 3 (a), swinging of the workpiece 2 and the seat 1 in the horizontal direction is shown by the dot-and-dash line and the dot-line; however, the spring 7 and the air cylinder 8 expand and contract in accordance with the width of the space between the seat 1 and the seat 6. FIG. 3 (a) illustrates the case where the spring 7 and the air cylinder 8 are used as the means for connecting the seat 1 and the seat 6 and for swinging the seat 6; however, the present invention is not limited thereto. For example, in place of the spring 7, another air cylinder differing from the air cylinder 8 may be used for swinging the seat 6. Also in place of the air cylinder 8, a hydraulic cylinder or the like may be used with no problem.

In FIG. 3 (a) and FIG. 3(b), the angle between the direction of the normal line 5a and the direction of the normal line 5b is referred to as a degree of swing θ, and in the present invention, the workpiece 2 may be swung in such a manner that the degree of swing θ could be more than 0 degree and preferably 7 degrees or less. The degree of swing θ corresponds to the angle between the straight line connecting the central axis 3a and the center of the rotational axis 9 in the case where the workpiece is at the position 2a and the straight line connecting the central axis 3b and the center of the rotational axis 9 in the case where the workpiece is at the position 2b.

In the present invention, in order that the degree of swing θ could fall within a predetermined range, for example, the above-mentioned (1) and (2) may be combined to swing both the resin-coated saw wire and the seat to which the workpiece is fixed.

Next, diamond abrasive grains for use in the present invention are described.

In cutting a workpiece with the above-mentioned resin-coated saw wire, the workpiece is cut while spraying abrasive grains onto the resin-coated saw wire. As the abrasive grains, diamond abrasive grains may be used. The present invention is directed to a workpiece except silicon, preferably to a hard material such as silicon carbide, and therefore, the abrasive grains to be used must have a high hardness.

It is important that the average grain size of the diamond abrasive grains is more than 0 μm and 8 μm or less. As described above, so far as at least one of the resin-coated saw wire or the workpiece is swung in cutting the workpiece, diamond abrasive grains having a relatively small grain size may be used to cut the workpiece by increasing the wire running speed of the resin-coated saw wire to 800 m/min or higher, as described hereinunder. In this case, since abrasive grains having a relatively small grain size are used, the arithmetic mean roughness Ra of the surface of the cut article may be reduced and the waviness may also be reduced. In the present invention, it is recommended to use diamond abrasive grains whose size is as small as possible, and the average grain size of the diamond abrasive grains is preferably 5 μm or less, more preferably 3 μm or less.

The average grain size of the diamond abrasive grains may be measured, for example, by using Microtrack HRA (device name) available from Nikkiso Co., Ltd.

As the above-mentioned diamond abrasive grains, for example, “SCM Fine Dia (trade name)” available from Sumiseki Materials Co., Ltd., may be used As the diamond abrasive grains, polycrystalline ones or single-crystal ones may be used, but single-crystal ones are preferably used since they are hardly broken in use for cutting.

For spraying the diamond abrasive grains, in general, a slurry prepared by dispersing the diamond abrasive grains in a processing liquid is used.

As the processing liquid, a water-soluble processing liquid or an oily processing liquid may be used. Examples of the water-soluble processing liquid include an ethylene glycol-based processing liquid “H4 (trade name)” available from Yushiro Chemical Industry Co., Ltd., a propylene glycol-based processing liquid “HISTAT TMD (trade name)” available from Sanyo Chemical Industries, Ltd., etc. Examples of the oily processing liquid include “Yushiron Oil (trade name)” available from Yushiro Chemical Industry Co., Ltd., etc.

The concentration of the diamond abrasive grains in the slurry is, for example, 0.5 to 20% by mass. Reducing the abrasive grains concentration may reduce the amount of the abrasive grains, but for keeping the abrasive grains concentration constant, the limit thereof is 0.5% by mass or so, and when the abrasive grains concentration is reduced more than the limit, it would be difficult to keep the abrasive grains concentration constant. The concentration of the diamond abrasive grains is preferably 1 to 10% by mass, more preferably 1 to 6% by mass.

The slurry temperature may be, for example, 10 to 30° C. A preferred lower limit of the slurry temperature is 20° C., and a preferred upper limit thereof is 25° C.

Next, the wire running speed of the resin-coated saw wire to be moved is described.

In the present invention, the resin-coated saw wire must be moved at a wire running speed of 800 m/min or higher. When the wire running speed is lower than 800 m/min, the grindability would be insufficient and the surface of the cut article would be waved even when at least one of the resin-coated saw wire or the workpiece is swung and diamond abrasive grains having a predetermined size are sprayed. Consequently, in the present invention, the wire running speed of the resin-coated saw wire is 800 m/min or higher. The wire running speed is preferably 1000 m/min or higher, more preferably 1300 m/min or higher. The upper limit of the wire running speed depends on the wire-saw machine performance, but it is for example, 2000 m/min or lower. The wire running speed means an average wire running speed.

On the other hand, the slicing speed of workpieces may be 0.1 to 0.35 mm/min.

As described above, the mode of swinging of the resin-coated saw wire or workpiece, the diamond abrasive grains and the wire running speed of the resin-coated saw wire that are features of the present invention have been described.

The resin-coated saw wire for use in the present invention has a resin coating that covers the surface of a steel wire, and basically the above-mentioned Patent Document 4 may be referred to.

Specifically, the steel wire as a base wire is, for example, preferably a steel wire having a tensile strength of 3000 MPa or more. Examples of the steel wire having a tensile strength of 3000 MPa or more include a high-carbon steel wire containing C in an amount of 0.5 to 1.2% by mass. Examples of the high-carbon steel wire include a piano wire rod defined in JIS G3502.

The diameter of the steel wire is preferably as small as possible within a tolerable range against the load given during cutting, and for example, the diameter is preferably 130 μm or less, more preferably 110 μm or less, even more preferably 100 μm or less. Reducing the diameter of the steel wire could reduce the kerf loss and therefore could enhance the productivity of the cut articles. However, when the diameter of the steel wire is too small, the risk of wire breakage may increase, and therefore, the diameter of the steel wire is, for example, preferably 50 μm or more.

As the resin to form the resin coating, a thermosetting resin or a thermoplastic resin may be used. Among such resins, a thermosetting resin such as phenolic resin, epoxy resin, polyurethane, imide-based resin and formal, as well as a thermoplastic resin such as vinyl chloride, acrylonitrile-butadiene-styrene resin, polyester, polyamide-imide and amide-based resin may be favorably used. In particular, polyurethane, polyimide and polyamide-imide are excellent in formability in covering with the resin coating and in hardness retentiveness at high temperatures and are therefore favorably used. Among these, polyamide-imide is most preferred.

The resin coating may be formed, for example, by applying a commercially-available varnish onto the surface of a steel wire and heating it. The varnish is a coating liquid prepared by dissolving a resin in a drying oil, an organic solvent or the like.

The vanish may be repeatedly applied as divided in a few times to a few dozen times, and accordingly, the thickness of the resin coating may be controlled.

As the varnish, for example, varnishes for enameled wires commercially available from Totoku Toryo Co., Ltd. and Ube Industries, Ltd.; and varnishes for electric wires commercially available from Kyocera Chemical Corporation may be used.

As the varnishes for enameled wires, for example, the following are usable.

(a) Polyurethane varnishes (“TPU F1”, “TPU F2-NC”, “TPU F2-NCA”, “TPU 6200”, “TPU 5100”, “TPU 5200”, “TPU 5700”, “TPU K5 132”, “TPU 3000K”, “TPU 3000EA”, etc.; commercial products available from Totoku Toryo Col, Ltd.)

(b) Polyamide-imide varnishes (“Neoheat AI-00C”, etc.; commercial products available from Totoku Toryo Co., Ltd.)

(c) Polyimide varnishes (“U-Varnish” etc.; commercial products available from Ube Industries, Ltd.)

(d) Polyester varnishes (“LITON 2100S”, “LITON 2100P”, “LITON 3100F”, “LITON 3200BF”, “LITON 3300”, “LITON 3300KF”, “LITON 3500SLD”, “Neoheat 8200K2”, etc.; commercial products available from Totoku Toryo Col, Ltd.)

(e) Polyester-imide varnishes (“Neoheat 8600A”, “Neoheat 8600AY”, “Neoheat 8600”, “Neoheat 8600H3”, “Neoheat 8625”, “Neoheat 8600E2”, etc.; commercial products available from Totoku Toryo Col, Ltd.)

Examples of the varnishes for electric wires usable herein include heat-resistant urethane varnishes for copper wires (“TVE5160-27”, etc., epoxy-modified formal resins), formal varnishes for copper wires (“TVE5225A”, etc., polyvinyl formal resins), heat-resistant formal varnishes for copper wires (“TVE5230-27”, etc., epoxy-modified formal resins), polyester varnishes for copper wires (“TVE5350 series”, polyester resins), etc. (all commercial products available from Kyocera Chemical Corporation).

The hardness of the resin coating, as measured at 120° C., is preferably 0.07 GPa or more. Control of the hardness as above suppresses the number of the abrasive grains intruded into the resin coating surface to at most 20 grains/(50 μm×200 μm). This allows the cut article to have a shallow damaged layer and allows the cut article surface to have an arithmetic mean roughness Ra of 0.5 μm or less. The hardness is more preferably 0.1 GPa or more. However, when the resin coating is excessively hard, the resin coating may hardly adhere to the cut surface during cutting of the workpiece, and the abrasive grains may be introduced into the space between the resin-coated saw wire and the workpiece cut surface to cause formation of a deep damaged layer in the cut surface. Accordingly, the hardness is, for example, preferably 0.5 GPa or less. More preferably, the hardness is 0.4 GPa or less.

The hardness of the resin coating can be measured typically by a nanoindentation method.

The resin coating may have a thickness of typically preferably 2 to 15 μm. When the thickness of resin coating is excessively small, it may be difficult to form the resin coating uniformly on the surface of the steel wire. In addition, when the thickness of the resin coating is excessively small, the resin coating may be worn away in early stages of cutting to thereby cause the steel wire as the base wire to be exposed, and this may cause the base wire to be abraded and to readily break. Thus, the resin coating has a thickness of preferably 2 μm or more, more preferably 3 μm or more. However, when the thickness of the resin coating is excessively large, the resin coating may cause the resin-coated saw wire to have a large diameter, and this may cause a larger kerf loss and inferior productivity of the cut articles. In this case, the resin occupies an excessively large percentage of the entire resin-coated saw wire, and this may cause the entire resin-coated saw wire to have insufficient strengths. Thus, when the wire running speed of the wire is increased to improve productivity of the cut articles, the wire may readily break. Accordingly, the resin coating has a thickness of preferably 15 μm or less, more preferably 13 μm or less, even more preferably 10 μm or less.

Not specifically limited, the diameter of the resin-coated saw wire is generally about 100 to 300 μm, preferably 100 to 150 μm.

Also not specifically limited, the workpiece to be cut with the resin-coated saw wire may be any one except silicon. For example, examples of the workpiece include ceramics, glass, oxides, nitrides, etc. The ceramics may be, for example, those containing silicon carbide or may be single-crystal silicon carbide. Examples of the oxides include sapphire that is an Al oxide. Examples of the nitrides include silicon nitrides and gallium nitrides. High-hardness materials such as silicon carbide, sapphire and gallium nitride are preferred.

Next, conditions for the manufacture of cut articles by cutting workpieces with the resin-coated saw wire will be described.

The tension (N) to be applied to the resin-coated saw wire is, as disclosed in the above-mentioned Patent Document 4, preferably set so as to satisfy the range of the following Expression (1) that is calculated on the basis of the tensile strength of the base wire of being a steel wire uncovered with a resin coating.

Tensile strength×0.5−5.0≦tension≦tensile strength×0.7−5.0 (1)

Not specifically limited, the swinging speed in swinging the resin-coated saw wire or the workpiece fixed to the seat along with the seat is, for example, preferably 140 to 200 degrees/min. The swinging speed is more preferably 160 to 180 degrees/min.

The kerf loss of the workpiece is controlled to be preferably approximately 1 to 1.10 times the diameter of the resin-coated saw wire, more preferably 1 to 1.05 times, even more preferably 1 to 1.04 times, still more preferably 1 to 1.03 times. With that, the productivity of cut articles can be enhanced.

The cut articles obtained by cutting workpieces with the above-mentioned resin-coated saw wire have extremely excellent surface quality. Specifically, the arithmetic mean roughness Ra of the surface of the cut articles is controlled to be preferably 0.5 μm or less, more preferably 0.4 μm or less, even more preferably 0.3 μm or less. The waviness of the surface of the cut article is controlled to be preferably 30 μm or less, more preferably 25 μm or less, even more preferably 20 μm or less, still more preferably 15 μm or less.

The arithmetic mean roughness Ra and the waviness are defined in JIS B0601 (1994), and the arithmetic mean roughness Ra and waviness of the surface of the cut article may be measured, for example, by using “CS-3200 (device name)” available from Mitutoyo Corporation. The measurement length may be at least 20 mm.

The present application claims the benefit of priority based on Japanese Patent Applications No. 2014-002740 filed on Jan. 9, 2014. The entire contents of the description in Japanese Patent Applications No. 2014-002740 are incorporated herein by reference.

Hereinunder the present invention is described concretely with reference to Examples given below, but the present invention is not limited to the following Examples and can be carried out with modifications and changes within a range complying with the purports described above and below, all of which fall within the technical scope of the present invention.

### EXAMPLES

Using a resin-coated saw wire having a resin coating that covers the surface of a steel wire, and using a wire-saw machine equipped with the resin-coated saw wire, workpieces were cut. As the wire-saw machine, “NWS21” available from Takatori Corporation was used.

The process for producing the resin-coated saw wire is as follows.

First, a wire material corresponding to “SWRS 82A” defined in JIS G3502 was drawn into a steel wire having a diameter φ of 100 μm, and then, it was degreased. The tensile strength of the degreased steel wire was 3000 MPa or more.

Next, a polyamide-imide varnish was applied onto the surface of the steel wire to form thereon a coating film having a thickness of 3.0 to 10.0 μm, and then, it was cured by heating at 300° C. to give a resin-coated saw wire. As the varnish, a varnish for enameled wires “Neoheat AI-00C (trade name)” available from Totoku Toryo Co., Ltd. was used. The diameter φ of the resultant resin-coated saw wire was 110 μm. The thickness of the resin coating is shown in Table 1.

The hardness of the resin coating of the resultant resin-coated saw wire was measured by the nanoindentation method. The hardness was measured both at room temperature (23° C.) and at 120° C. Specific measurement conditions are as follows.

### <<Common Measurement Conditions Both at Room Temperature and at 120° C.>>

Measurement Equipment: “Nano Indenter XP/DCM” available from Agilent Technologies

Analysis Software: “Test Works 4” available from Agilent Technologies

Indenter Head: XP

Strain Rate: 0.05/second

Measurement Point Interval: 30 μm

Reference Standard: fused silica

### <<Measurement Conditions at Room Temperature>>

Measurement Mode: Continuous Stiffness Measurement (CSM)

Excited Vibration Frequency: 45 Hz

Excited Vibration Amplitude: 2 nm

Indentation Depth: 450 nm

Measurement Points: 15 points

Measurement Environment: at room temperature of 23° C. in an air-conditioned chamber

The hardness at room temperature was measured at a position corresponding to an indentation depth from the resin coating outermost surface of 450 nm. The results measured at 15 points were averaged, and the hardness was 0.31 GPa. In the hardness measurement, outlier exception as follows was basically performed. However, such outlier was not observed in this experimental example.

Specifically, a value which is 3 times or more greater than the average, or one-third or less smaller than the average is defined as an outlier. Such outlier, if included in the measured data, is excluded, and a datum newly measured is added to the measured data so as to measure the hardness at a total of 15 measurement points.

### <<Measurement Conditions at 120° C.>>

Measurement Mode: Unloading Measurement Technique

Indentation Depth: 450 nm

Measurement Points: 10 points

Measurement Environment: The sample tray was held at 120° C. using an electrical resistance heater.

The hardness at 120° C. was measured at a position corresponding to an indentation depth from the resin coating outermost surface of 450 nm. Specifically, the hardness measurement with sample heating could not employ the continuous stiffness measurement technique as in the hardness measurement at room temperature. Thus, the hardness measurement was performed by adjusting the load so that the measurement position be a position at an indentation depth from the outermost surface of 450 nm. For heating, the resin-coated saw wire was stuck to a metal-made nanoindentation sample tray with a ceramic adhesive, and the sample tray was heated with an electrical resistance heater, and thus, the hardness of the sample was measured while keeping at 120° C.

The results measured at 10 points were averaged, and the hardness was 0.28 GPa. In the hardness measurement, outlier exception as follows was basically performed. However, such outlier was not observed in this experimental example.

Specifically, a value which is 3 times or more greater than the average, or one-third or less smaller than the average is defined as an outlier. Such outlier, if included in the measured data, is excluded, and a datum newly measured is added to the measured data so as to measure the hardness at a total of 10 measurement points.

As the workpiece, a single-crystal ingot of silicon carbide was used. The ingot was columnar having a size of 2 inches in diameter φ.

The workpiece was cut based on the schematic view of FIG. 2. Specifically, the resin-coated saw wire 4 was arranged to crawl below the workpiece 2, and the workpiece 2 was brought into contact with the resin-coated saw wire 4 to be cut thereby. At that time, a slurry prepared by suspending diamond abrasive grains in a working oil was sprayed onto the resin-coated saw wire 4. As the slurry, one prepared by suspending “SCM Fine Dia (trade name)” available from Sumiseki Materials Co., Ltd. in “Ethylene Glycol Working Liquid H4 (trade name)” available from Yushiro Chemical Industry Co., Ltd. was used. The “SCM Fine Dia (trade name)” is diamond abrasive grains. The average grain size of the diamond abrasive grains is shown in Table 1 below.

For cutting the workpiece 2, the slicing speed was 0.1 mm/min, and the wire running speed of the resin-coated saw wire 4 was 500 to 1300 m/min. The average wire running speed is shown in Table 1 below.

In Nos. 2 to 16, the resin-coated saw wire 4 was swung in cutting the workpiece 2. The swinging speed of the resin-coated saw wire 4 was 170 degrees/min. Among the normal lines of the resin-coated saw wire 4, the maximum value of the degree of swing in the direction of the normal line passing through the central axis 3 of the workpiece 2 is shown in Table 1 below.

As a control for comparison, the workpiece 2 was cut without swinging the resin-coated saw wire 4, and the results are shown in No. 1 in Table 1 below. The degree of swing in No. 1 is 0 degree.

After the workpiece 2 was cut, the surface of the resin-coated saw wire was observed with eye and with an optical microscope to confirm the presence or absence of abrasion of the resin coating. The case where the resin coating was worn away and where at least a part of the resin coating was lost in observation with the eye or at least a part of the steel wire was exposed in observation with the optical microscope was evaluated as “worn”. The case where the resin coating was not worn away and the steel wire was not exposed was evaluated as “not worn”. The evaluation results are shown in Table 1 below.

When the workpiece 2 was cut with the resin-coated saw wire 4 moving thereon, the resin-coated saw wire was checked for the presence or absence of breakage thereof. The results are shown in Table 1 below.

Next, in Nos. 1 to 5 and 9 to 16 where the resin coating was not worn away after cutting of the workpiece 2, the arithmetic mean roughness Ra and waviness of the surface of the cut article obtained by cutting the workpiece 2 were measured. The arithmetic mean roughness Ra and waviness of the surface of the cut article were measured in the cutting direction that is a direction perpendicular to the grinding trace called a saw mark, according to JIS B0601 (1994). For measurement of the arithmetic mean roughness Ra and waviness of the surface of the cut article, “CS-3200 (device name)” manufactured by Mitutoyo Corporation was used, and the measurement depth was 25 mm in every case. The measurement results are shown in Table 1 below. Samples whose arithmetic mean roughness Ra was 0.5 μm or less were evaluated as accepted products; and samples whose arithmetic mean roughness Ra was more than 0.5 μm were evaluated as rejected products. Regarding the waviness, samples whose waviness was 30 μm or less were evaluated as accepted products; and samples whose waviness was more than 30 μm were evaluated as rejected products. In Table 1 below, “-” means that the sample was not analyzed.

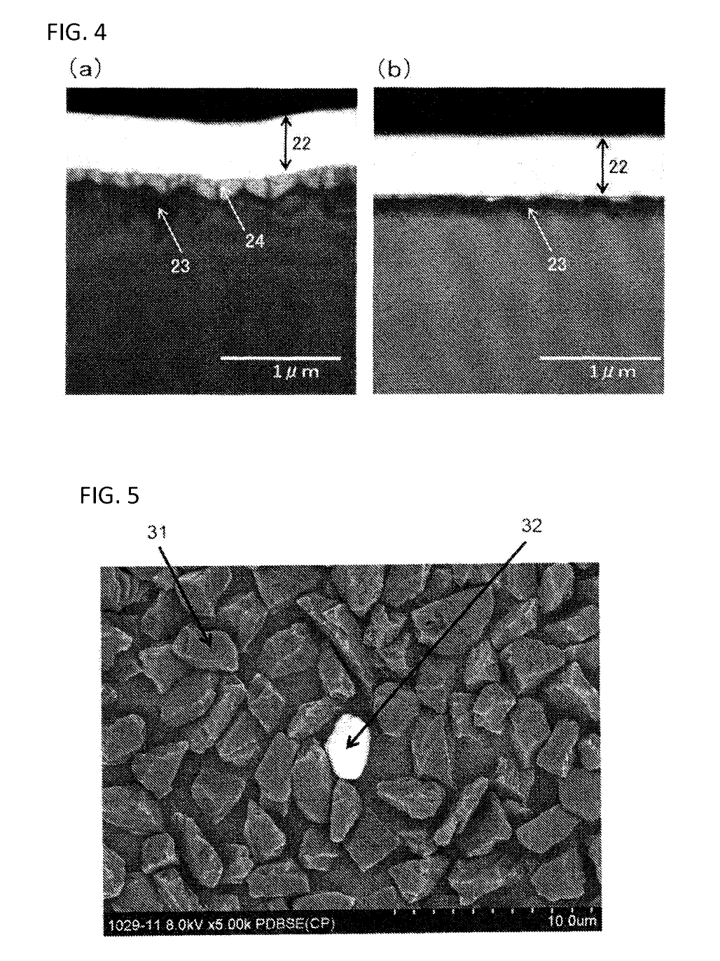

Next, in No. 1 and No. 3 in Table 1 below, for observing the surface quality of the cut articles, a carbon coating film as a protective film was formed on the surface of the cut article according to a sputtering method, and the cut surface was exposed and observed with a transmission electron microscope. FIG. 4 (a) shows a photograph substituted for drawing of the cut surface in No. 1; and FIG. 4 (b) shows a photograph substituted for drawing of the cut surface in No. 3. In FIG. 4, 22 indicates the protective film, 23 indicates dislocation, and 24 indicates a recovered layer.

Based on Table 1 below and FIG. 4, the following discussion may be provided.

Nos. 2 to 5, 9 to 12, and 14 to 16 are cases satisfying the requirements defined in the present invention. While a moving resin-coated saw wire is swung, diamond abrasive grains having an average grain size of more than 0 μm and 8 μm or less are sprayed onto the resin-coated saw wire and the wire running speed of the resin-coated saw wire is adjusted to be 800 m/min or more, and as a result, the resin coating was not warn away and the resin-coated saw wire did not break during cutting workpieces. In addition, with regard to the cut articles obtained by cutting workpieces, the arithmetic mean roughness Ra of the surface was small and the waviness thereof was also small, and the cut articles had high quality.

Precisely, Nos. 2 to 5 are examples where the average grain size of the diamond abrasive grains was 3.0 μm, the wire running speed of the resin-coated saw wire was 1000 m/min, and the degree of swing of the resin-coated saw wire was varied. The arithmetic mean roughness Ra and waviness of the surface of the cut articles in Nos. 2 to 5 varied little and were nearly constant values. This may be considered as follows: even when the maximum value of the degree of swing is increased to the upper limit that is recommended in the present invention and the number of the abrasive grains to be introduced into the space between the workpiece and the resin-coated saw wire is increased, the number of the abrasive grains that may contribute to cutting of workpieces would not substantially change.

Nos. 9 to 12 are examples where the degree of swing of the resin-coated saw wire was 1 degree, the wire running speed of the resin-coated saw wire was 1000 m/min, and the average grain size of the diamond abrasive grains was varied. As obvious from these results, it is found that when the average grain size of the diamond abrasive grains was reduced more, the arithmetic mean roughness Ra and waviness of the surface of the cut article surface became smaller. In particular, when the average grain size of the diamond abrasive grains to be used was 1.8 μm, the arithmetic mean roughness Ra of the cut article surface could be reduced to 0.17 μm and the waviness thereof could be reduced to 13 μm.

Nos. 14 to 16 are examples where the degree of swing of the resin-coated saw wire was 1 degree, the average grain size of the diamond abrasive grains was 1.8 μm and the wire running speed of the resin-coated saw wire was varied. As obvious from these results, it is found that when the wire running speed of the resin-coated saw wire was increased more, the arithmetic mean roughness Ra and waviness of the cut article surface became smaller. In particular, when the wire running speed of the resin-coated saw wire was 1300 m/min, the arithmetic mean roughness Ra of the cut article surface was 0.11 μm and the waviness thereof was 10 μm. Thus, dramatically better cut articles which heretofore could not be obtained at all were obtained.

As described above, in Nos. 2 to 5, 9 to 12 and 14 to 16 satisfying the requirements defined in the present invention, the slicing speed of the workpieces is 0.1 mm/min and is constant. In general, it is a matter of common sense that reducing the grain size of abrasive grains worsens the grindability and lowers the slicing speed, but in the present invention, even when the grain size of the abrasive grains to be used is reduced, a high slicing speed can be maintained and, in addition, the arithmetic mean roughness Ra and waviness of the surface of the cut articles can be greatly improved. Therefore, according to the present invention, an unconventional effect of improving the grindability of workpieces can be obtained.

As opposed to these, Nos. 1, 8 and 13 are cases not satisfying the requirements defined in the present invention.

Among these, No. 1 is a case where the resin-coated saw wire 4 is not swung in cutting and the degree of swing is 0 degree. As shown in Table 1 below, in No. 1, the resin coating was not worn away even after cutting, the resin-coated saw wire did not break during cutting the workpieces, and the arithmetic mean roughness Ra of the surface of the cut article was 0.5 μm or less and was small. However, the surface of the cut article greatly waved.

No. 8 is a case using diamond abrasive grains whose average grain size is larger than the range defined in the present invention, and the resin coating was worn away in cutting workpieces.

No. 13 is a case where the wire running speed of the resin-coated saw wire is lower than the range defined in the present invention, and the surface of the cut article waved.

Nos. 6 and 7 are reference examples in which the resin-coated saw wire 4 was swung excessively. Of these, in No. 6, the maximum value of the degree of swing was 10.0 degrees exceeding the recommended range in the present invention. As a result, the resin-coated saw wire did not break in cutting workpieces, but on the surface of the resin-coated saw wire after cutting, the resin coating was worn away. In No. 7, the maximum value of the degree of swing was 20.0 degrees, twice in the case of No. 6. As a result, during cutting workpieces, the resin-coated saw wire broke. In addition, on the surface of the resin-coated saw wire after breaking, the resin coating was worn away.

According to FIG. 4 (a), it is found that, when the workpiece is cut without swinging the resin-coated saw wire 4 for which the degree of swing is 0 degree, the dislocation introduced during cutting could be partly recovered to form a recovered layer. Specifically, it is considered that the recovered layer could be formed by temperature increase during cutting, and in the case of cutting with no swinging of the saw wire for which the degree of swing is 0 degree, the cutting performance would be insufficient, and even though temperature increase was occurred in such a degree that the recovered layer could be formed, oxidation to be mentioned hereinunder could not occur and the cutting performance would be therefore insufficient. It is considered that such insufficient cutting performance would have increased the waviness of the surface of the cut article.

Contrary to this, as shown in FIG. 4 (b), in the case where workpieces were cut with swinging the resin-coated saw wire 4, a recovered layer was hardly observed on the surface of the cut article. In addition, as compared with the case in the above-mentioned FIG. 4 (a) where the degree of swing in cutting was 0 degree, the depth of the dislocation was equal to or less than half, and it is found that the cutting performance was improved by swinging of the resin-coated saw wire. As a result, it is considered that the waviness of the surface of the cut article could be reduced.

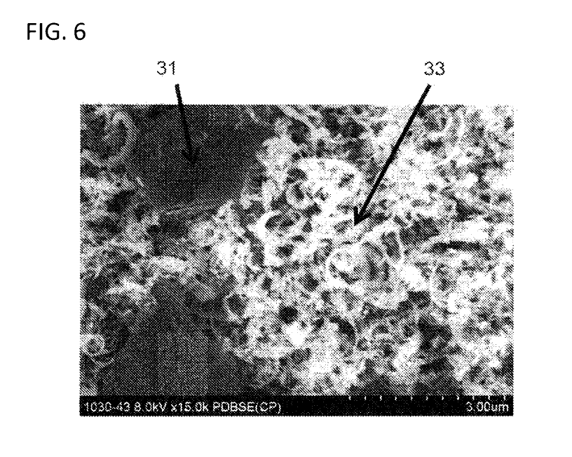

Next, for investigating the relationship between the presence or absence of swinging of the resin-coated saw wire and the recovered layer to be formed on the surface of the cut article, the present inventors took particular note of the shape of the cutting chips to be formed during cutting workpieces, and observed the cutting chips with a scanning electron microscope. Specifically, in No. 1 and No. 3 in Table 1 below, the cutting chips having formed in cutting the workpieces were observed with a scanning electron microscope. FIG. 5 shows a photograph substituted for drawing of the cutting chips formed and taken in No. 1, and FIG. 6 shows a photograph substituted for drawing of the cutting chips formed and taken in No. 3. In FIG. 5 and FIG. 6, 31 indicates a diamond abrasive grain.

As shown in FIG. 5, the cutting chip 32 having formed in the case of cutting a workpiece without swinging the resin-coated saw wire was in a form of a bulky grain. On the other hand, as shown in FIG. 6, the cutting chip 33 having formed in the case of cutting a workpiece with swinging the resin-coated saw wire was in a form of a curled thin string.

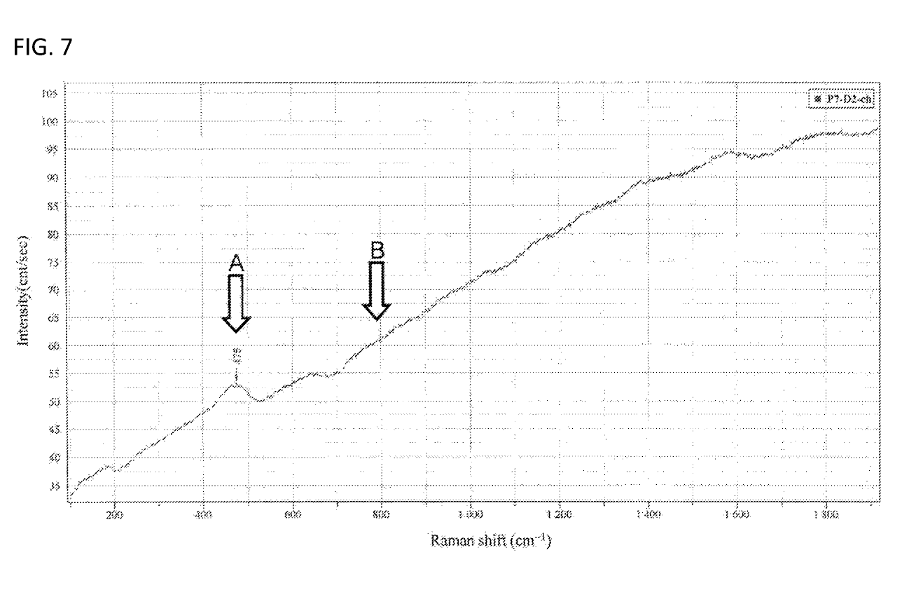

Then, for investigating the reason why the shape of the cutting chips having formed in No. 3 was in the form of a curled thin string, the cutting chips were analyzed through Raman microspectrophotometry. In the Raman microspectrophotometry, a laser Raman microspectrophotometer “LabRAM HR-800” available from Horiba, Ltd. was used. FIG. 7 shows the analysis result. In FIG. 7, the arrow A indicates a peak position indicating the presence of an Si—O bond, and the arrow B indicates a peak position indicating the presence of an Si—C bond.

### <<Analysis Conditions>>

Laser Wavelength: 514.5 nm

Laser Power: 0.2 mW

Laser Irradiation Range: bout 1 μm

Exposure Time: 120 seconds

Number of Integration Frequencies: 8 times

Diffraction Grating: 600 gr/mm

Confocal Hole Diameter: 100 μm

As obvious from FIG. 7, in No. 3 where single-crystal silicon carbide was cut, the cutting chips having formed in cutting the single-crystal silicon carbide gave no peak indicating the presence of an Si—C bond though they gave a peak indicating the presence of an Si—O bond. As obvious from the result, it has become obvious that the cutting chips are not silicon carbide but are silicon oxide. It is considered that, by swinging the resin-coated saw wire, there would have occurred significant temperature increase at the edges of the diamond abrasive grains in cutting silicon carbide, and accordingly silicon carbide would be oxidized to be SiCO, and would be finally changed to SiO₂ and CO₂.

Specifically, as shown in the above FIG. 4 (a), in the case of cutting workpieces without swinging the resin-coated saw wire, it is considered that a recovered layer would be formed on the surface of the cut article, therefore resulting in significant temperature increase in cutting. The cutting chips having formed in cutting are in a form of bulky grains, as shown in FIG. 5, and it is considered that the workpiece of single-crystal silicon carbide would have been ground to thereby give the cutting chips of such a form. In this case, the waviness of the surface of the cut article was large.

Contrary to this, as shown in FIG. 6, the cutting chips having formed in the case of cutting the workpiece with swinging the resin-coated saw wire were in a form of curled thin strings. The cutting chips are oxides as shown in FIG. 7. This indicates that the temperature was raised more in the case of cutting the workpiece with swinging the resin-coated saw wire than the case of cutting the workpiece without swinging it, and it is considered that owing to such further temperature increase, the surface of the workpiece would be oxidized, and by chipping off the oxide film, the cutting of the workpiece would be seemingly promoted more. Specifically, it is considered that, according to the cutting method in the present invention, grinding and oxidation of workpieces could be carried out simultaneously, thereby realizing smooth cutting and, as a result, even though the slicing speed is not lowered, the arithmetic mean roughness Ra and waviness of the surface of the cut article could be significantly reduced.

It is considered that the reason why the temperature in cutting could be raised markedly by swinging the resin-coated saw wire would be as follows: diamond abrasive grains having a small average grain size are used and additionally the wire running speed of the resin-coated saw wire is increased. Specifically, in Table 1 below, the concentration of the diamond abrasive grains was fixed to 5% by mass and therefore, as shown in Nos. 9 to 12, with reduction in the average grain size of the diamond abrasive grains used, the number of the diamond abrasive grains contained in the slurry increases. Consequently, it is considered that using diamond abrasive grains having a smaller average grain size increases the number of the edges of the diamond abrasive grains, resulting in further markedly increase of the temperature in cutting. In addition, by increasing the wire running speed of the resin-coated saw wire, the temperature in cutting could be further markedly increased.

As described above, by swinging the moving resin-coated saw wire while spraying diamond abrasive grains whose average grain size is more than 0 μm and 8 μm or less onto the resin-coated saw wire, and by adjusting the wire running speed of the resin-coated saw wire to be 800 m/min or more, grinding and oxidation can be attained simultaneously and, as a result, cut articles having better quality than ever before can be obtained without sacrificing the slicing speed.

TABLE 1

| | Degree of | Abrasive | Average Wire | | Abrasion of | | | |
|---|---|---|---|---|---|---|---|---|
| | Swing | Grains | running speed | Thickness | Resin | Wire | Arithmetic Mean | Waviness |
| No. | (degree) | (μm) | (m/min) | (μm) | Coating | Breaking | Roughness (μm) | (μm) |
| 1 | 0 | 3.0 | 1000 | 5.0 | no | no | 0.47 | 35 |
| 2 | 0.6 | 3.0 | 1000 | 5.0 | no | no | 0.47 | 18 |
| 3 | 1.0 | 3.0 | 1000 | 5.0 | no | no | 0.32 | 8 |
| 4 | 2.0 | 3.0 | 1000 | 5.0 | no | no | 0.40 | 17 |
| 5 | 4.0 | 3.0 | 1000 | 5.0 | no | no | 0.44 | 21 |
| 6 | 10.0 | 3.0 | 1000 | 5.0 | yes | no | — | — |
| 7 | 20.0 | 3.0 | 1000 | 5.0 | yes | yes | — | — |
| 8 | 1.0 | 10.0 | 1000 | 10.0 | yes | no | — | — |
| 9 | 1.0 | 7.0 | 1000 | 10.0 | no | no | 0.45 | 30 |
| 10 | 1.0 | 5.0 | 1000 | 5.0 | no | no | 0.35 | 28 |
| 11 | 1.0 | 3.0 | 1000 | 5.0 | no | no | 0.17 | 17 |
| 12 | 1.0 | 1.8 | 1000 | 3.0 | no | no | 0.17 | 13 |
| 13 | 1.0 | 1.8 | 500 | 3.0 | no | no | 0.45 | 48 |
| 14 | 1.0 | 1.8 | 800 | 3.0 | no | no | 0.30 | 26 |
| 15 | 1.0 | 1.8 | 1000 | 3.0 | no | no | 0.17 | 13 |
| 16 | 1.0 | 1.8 | 1300 | 3.0 | no | no | 0.11 | 10 |

### REFERENCE SIGNS LIST

1, 1a, 1b Seat
2, 2a, 2b Workpiece
3, 3a, 3b Central Axis
4, 4a, 4b Resin-Coated Saw Wire
5a, 5b Direction of Normal Line passing through central axis of workpiece
6 Seat
7 Spring
8 Air Cylinder
9 Rotational Axis
11 Steel Wire
12 Saw Wire formed of steel wire
13 Running Direction of Saw Wire
14 Workpiece
15 Loose Abrasive
16 Plating Layer
17 Fixed Abrasive
18 Fixed Abrasive-Bearing Saw Wire
19 Resin Coating
20 Resin-Coated Saw Wire
21 Released Loose Abrasive
22 Protective Film
23 Dislocation
24 Recovered Layer
31 Diamond Abrasive Grain
32 Cutting Chip
33 Cutting Chip
θ Degree of Swing

1: A method for cutting a workpiece except silicon, comprising moving a resin-coated saw wire having a resin coating that covers the surface of a steel wire, wherein:
at least one of the resin-coated saw wire or the workpiece is swung,
a diamond abrasive grain having an average grain size of more than 0 μm and 8 μm or less is sprayed onto the resin-coated saw wire, and
a wire running speed of the resin-coated saw wire is 800 m/min or higher.

2: The method according to claim 1, wherein the average grain size of the diamond abrasive grain is more than 0 μm and 5 μm or less.

3: The method according to claim 1, wherein the wire running speed of the resin-coated saw wire is 1000 m/min or higher.

4: The method according to claim 1, wherein a degree of swing in a direction of a normal line that passes through the central axis of the workpiece, among normal lines of the resin-coated saw wire, is more than 0 degree.

5: The method according to claim 4, wherein the degree of swing is more than 0 degree and 7 degrees or less.

6: The method according to claim 1, wherein a hardness of the resin coating at 120° C. is 0.07 GPa or more.

7: The method according to claim 1, wherein the resin is polyurethane, polyimide or polyamide-imide.
